(19) United States
(12) Patent Application Publication
(10) Pub. No.: US 2014/0078661 A1
(43) Pub. Date: Mar. 20, 2014

(54) SERVER CABINET

(71) Applicant: WEN-JEN WU, Tu-Cheng (TW)

(72) Inventor: WEN-JEN WU, Tu-Cheng (TW)

(21) Appl. No.: 13/631,755

(22) Filed: Sep. 28, 2012

(30) Foreign Application Priority Data
Sep. 14, 2012 (TW) 101133615

(51) Int. Cl. G06F 1/20

(52) U.S. Cl. 361/679.31

(57) ABSTRACT

A server cabinet includes a rack and a server installed in the rack. The rack includes a top wall, a bottom wall, four support poles respectively connected between four corners of each of the top wall and the bottom wall, four moving plates movably mounted at inner sides of the support poles, two opposite fixing poles respectively positioned between a side of the top wall and a side of the bottom wall, and two opposite rails rotatably connected to inner surfaces of the fixing poles, respectively. The server is sandwiched between the rails. Two opposite ends of each rail are respectively and rotatably connected to corresponding two of the moving plates. When the two of moving plates located at a same end of the rack are moved down to tilt the rails, thus causing the server to tilt.

### BACKGROUND

1. Technical Field

The present disclosure relates to a server cabinet.

2. Description of Related Art

A server cabinet usually includes a rack and many servers horizontally arranged in the rack. It is well known that the servers in such an arrangement may generate a considerable amount of heat during operation, particularly when they densely occupy the cabinet space. If the heat is not efficiently removed, the servers may suffer damage. Thus, heat dissipation for the cabinet is very important.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a server cabinet, wherein the server cabinet includes a plurality of connecting members.

FIG. 2 is an exploded, isometric view of one of the connecting members of FIG. 1.

FIG. 3 is a partially enlarged view of FIG. 1

FIG. 4 is similar to FIG. 3, but shows a state of use.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

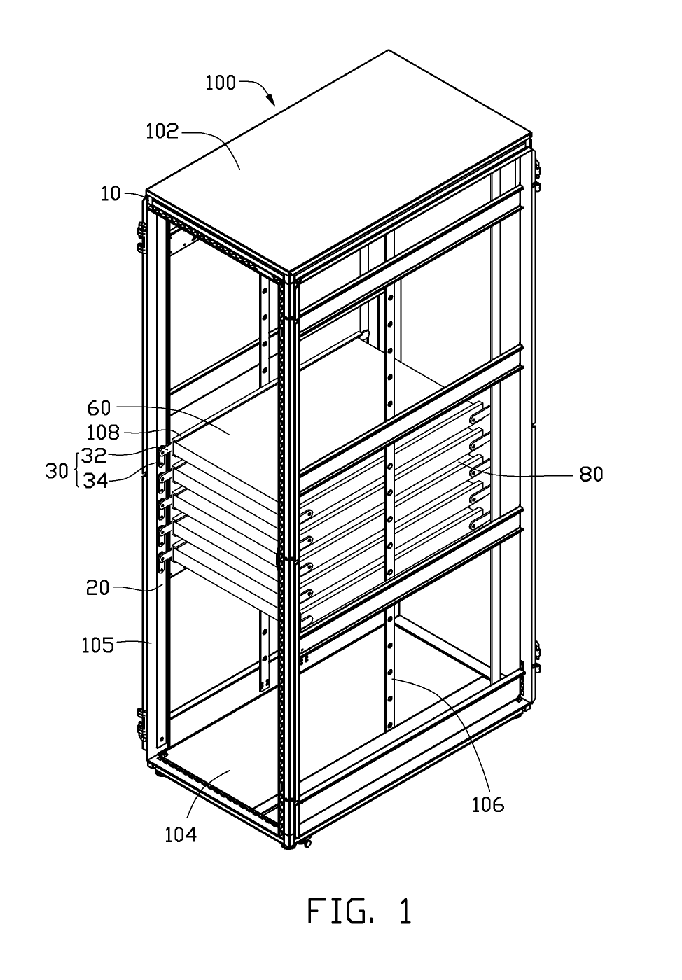

FIG. 1 shows an exemplary embodiment of a server cabinet 100. The server cabinet 100 includes a rack 10 and a plurality of servers 60 installed in the rack 10.

The rack 10 includes a rectangular top wall 102, a rectangular bottom wall 104 opposite to the top wall 102, four support poles 105 respectively connected between corresponding corners of the top wall 102 and the bottom wall 104 in a perpendicular manner, two opposite fixing poles 106 respectively connected between corresponding sides of the top wall 102 and the bottom wall 104 in a perpendicular manner, four moving plates 20 movably mounted up and down to inner sides of the support poles 105, and a plurality pairs of opposite rails 108. Opposite ends of each rail 108 are rotatably connected to inner surfaces of the corresponding fixing poles 106. A connecting member 30 is connected between an end of each rail 108 and the corresponding moving plate 20. Each connecting member 30 includes a bar-shaped first connecting piece 32 and a bar-shaped second connecting piece 34. A first end of the first connecting piece 32 is fixed to the rail 108. A first end of the second connecting piece 34 is fixed to the moving plate 20. A second end of the first connecting piece 32 is rotatably connected to a second end of the second connecting piece 34.

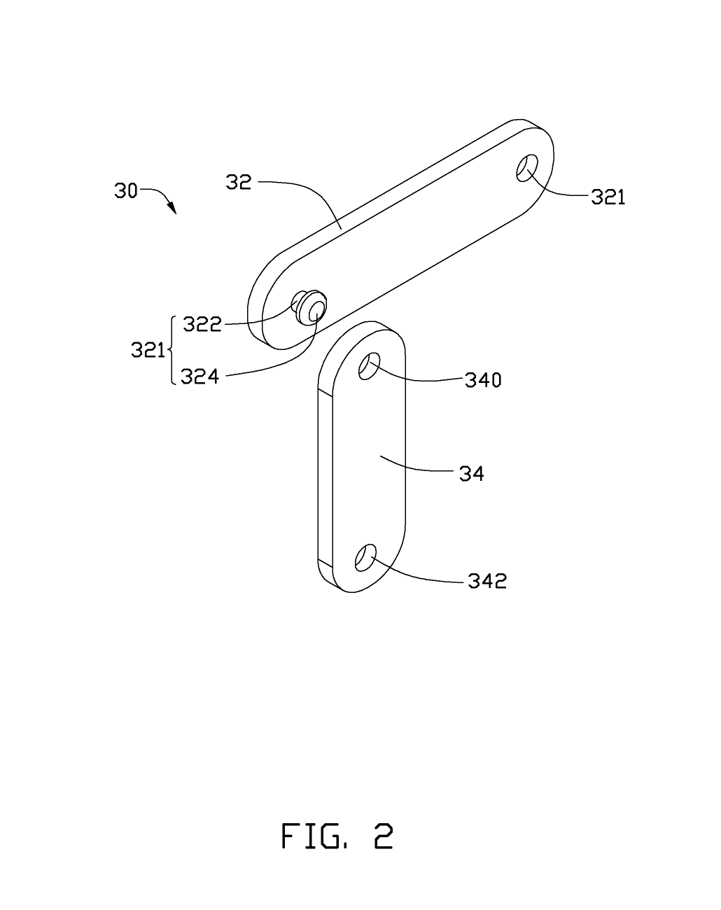

Referring to FIG. 2, a protrusion 321 protrudes from the second end of the first connecting piece 32. The protrusion 321 includes a cylindrical neck portion 322 perpendicularly extending out from the first connecting piece 32, and a semi-spherical resilient head portion 324 protruding out from a distal end of the neck portion 322 opposite to the first connecting piece 32. A diameter of the head portion 324 is greater than a diameter of the neck portion 322. The first end of the first connecting piece 32 defines a through hole 321. The second end of the second connecting piece 34 defines a pivot hole 340. The first end of the second connecting piece 34 defines a position hole 342. In assembling each connecting member 30, the protrusion 321 is inserted into the pivot hole 340 of the second connecting piece 34 under deforming the head portion 324, until the head portion 324 passes through the pivot hole 340. The neck portion 322 is rotatably extended through the pivot hole 340. The head portion 324 is restored to engage an outer surface of the second connecting piece 34 opposite to the first connecting piece 32. Therefore, the second connecting piece 34 is rotatably connected to the first connecting piece 32.

A screw extends through the through hole 321 of each connecting member 30 to screw in the corresponding rail 108, to fix the first connecting piece 32 to the corresponding rail 108. A screw extends through the position hole 342 of each connecting member 30 to screw in the corresponding moving plate 20, to fix the second connecting pieces 34 to the moving plate 20. Thereby, the ends of each rail 108 are rotatably connected to the corresponding moving plates 20.

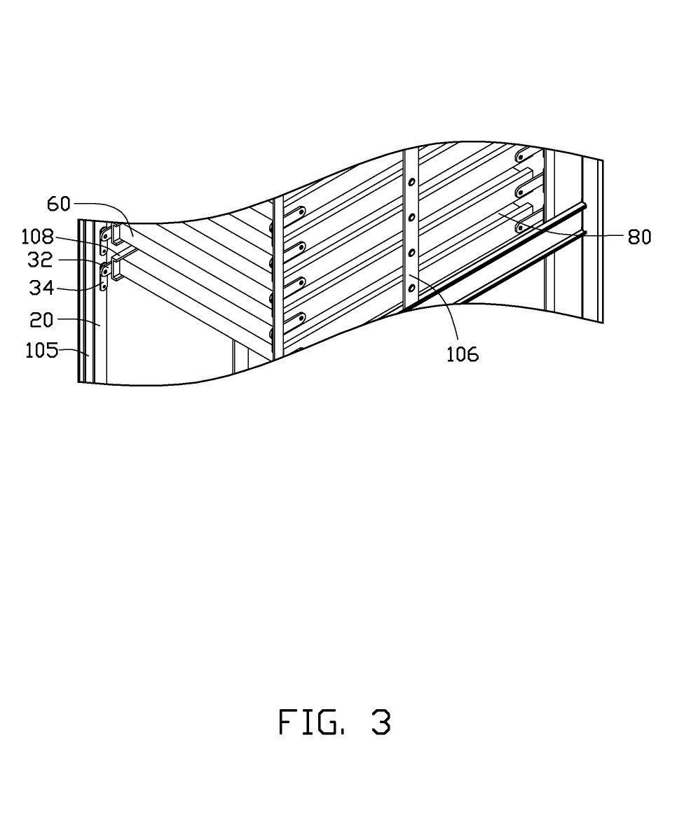

Referring to FIG. 3, each server 60 is inserted into a corresponding pair of rails 108 and is sandwiched between the pair of rails 108. Thereby, the rails 108 and the server 60 are parallel to the top wall 102. The first connecting piece 32 of each connecting member 30 is perpendicular to the second connecting piece 34 of the connecting member 30. Two adjacent servers 60 cooperatively bound a ventilation slot 80 parallel to the top wall 102.

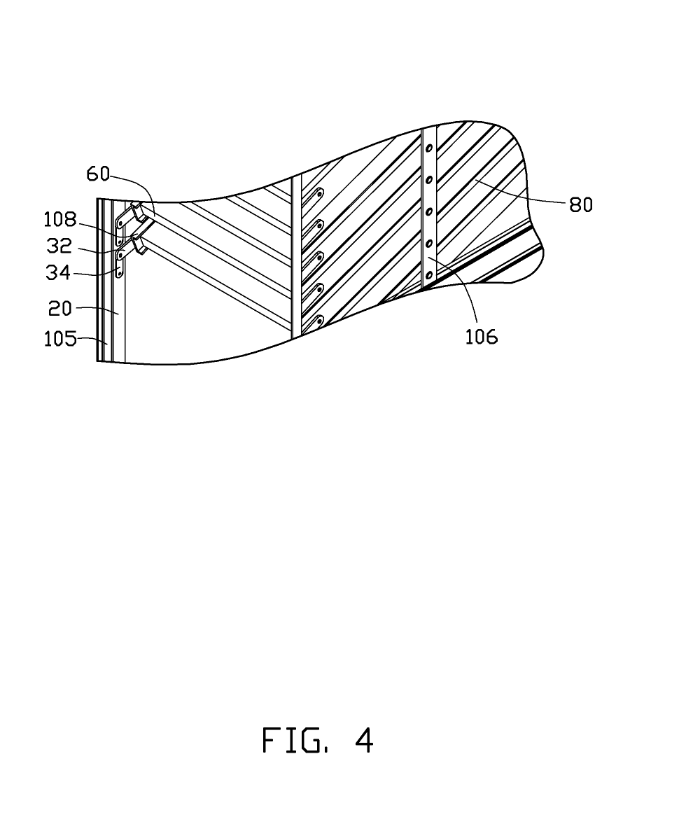

Referring to FIG. 4, in use, the moving plates 20 located at the front end of the rack 10 are moved down. The first connecting pieces 322 are rotated relative to the corresponding second connecting pieces 324 at the front end of the rack 10. Thus, front ends of the servers 60 tilt down, and the rear ends of the servers 60 tilt up. The moving plates 20 are positioned to the corresponding support poles 105 by screwing. Thereby, the ventilation slots 80 are slantwise. The heat generated by the servers 60 can be expediently dissipated out of the rear end of the rack 10 along the ventilation slots 80.

Even though numerous characteristics and advantages of the embodiments have been set forth in the foregoing description, together with details of the structure and function of the embodiments, the present disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A server cabinet, comprising:
a rack comprising a top wall, a bottom wall, four support poles respectively connected between four corners of each of the top wall and the bottom wall, four moving plates movably mounted to inner sides of the support poles, two opposite fixing poles respectively connected between sides of the top wall and the bottom wall, and two opposite rails rotatably connected to inner surfaces of the fixing poles, respectively; and
a server sandwiched between the rails; wherein two opposite ends of each rail are respectively and rotatably connected to corresponding two of the moving plates, the two of moving plates located at a same end of the rack are operable to be moved down to tilt the rails, thus causing the server to tilt.

2. The server cabinet of claim 1, wherein a connecting member is connected between each end of each rail and the corresponding moving plate, the connecting member comprises a first connecting piece fixed to the rail and a second connecting piece fixed to the moving plate, the first connecting piece is rotatably connected to the second connecting piece.

3. The server cabinet of claim 2, wherein the first connecting piece comprises a first end fixed to the corresponding rail and a second end opposite to the first end, the second connecting piece comprises a first end fixed to the corresponding moving plate and a second end rotatably connected to the second end of the first connecting piece.

4. The server cabinet of claim 3, wherein a protrusion protrudes from the second end of the first connecting piece, the second end of the second connecting piece defines a pivot hole, the protrusion is rotatably received in the pivot hole.

5. The server cabinet of claim 4, wherein the protrusion comprises a neck portion extending out from the first connecting piece and rotatably received in the pivot hole of the second connecting piece, and a head portion protruding out from a distal end of the neck portion and engaging with an outer surface of the second connecting piece away from the first connecting piece.
